(19) United States
(12) Patent Application Publication
(10) Pub. No.: US 2023/0169142 A1
(43) Pub. Date: Jun. 1, 2023

(54) OPTIMAL SOLUTION CALCULATION DEVICE FOR OPTIMIZATION PROBLEM AND OPTIMAL SOLUTION CALCULATION METHOD FOR OPTIMIZATION PROBLEM

(71) Applicant: Mitsubishi Electric Corporation, Tokyo (JP)

(72) Inventors: Junya HATTORI, Tokyo (JP); Masaya ENDO, Tokyo (JP); Yuko OMAGARI, Tokyo (JP)

(73) Assignee: Mitsubishi Electric Corporation, Tokyo (JP)

(21) Appl. No.: 17/919,432

(22) PCT Filed: Jun. 4, 2020
(86) PCT No.: PCT/JP2020/022063

§ 371 Date: Oct. 17, 2022

(51) Int. Cl. G06F 17/12

(52) U.S. Cl. CPC G06F 17/12

(57) ABSTRACT

An optimal solution calculation device for an optimization problem includes an initial condition generation unit for generating an executable initial solution and an equality constraint set with respect to an optimization problem, an optimization calculation unit for calculating a solution of a simultaneous linear equation generated from an evaluation function and for calculating an evaluated solution that is a solution to minimize or maximize the evaluation function, and an update unit. A convergence determination unit of the optimization calculation unit determines that an iterative solution has converged when a residual norm is equal to or less than a convergence determination threshold value, and outputs the converged iterative solution as the evaluated solution. The update unit determines the evaluated solution as an optimal solution when an update of the equality constraint set is determined to be unnecessary, and the convergence determination threshold value is the first threshold value.

### TECHNICAL FIELD

The present application relates to an optimal solution calculation device for an optimization problem and an optimal solution calculation method for an optimization problem.

### BACKGROUND ART

The design of a product is performed so as to optimize the shape, the arrangement, etc. thereof. In the design of a control method, an optimum process is constructed so as to control a control target with predetermined accuracy. Therefore, the design of a product and the design of a control method can be understood to be an operation for solving an optimization problem. Patent Document 1 discloses a structural optimal design method and a structural optimal design device for a structure, which are examples of an optimal solution calculation device for an optimization problem and an optimal solution calculation method for an optimization problem, namely, a device and a method for solving an optimization problem. The structural optimal design method of Patent Document 1 is a method for solving a bi-level structural optimization problem, which is a method for solving an optimization problem of a state variable vector for each iteration step of an optimization problem of a design variable vector. The structural optimal design device disclosed in Patent Document 1 has a first solving means for solving an optimization problem of a first evaluation functional with respect to the state variable vector and the design variable vector, and a second solving means for solving an optimization problem of a second evaluation functional with respect to the state variable vector and the design variable vector, and solves a structural optimal design problem formulated as a bi-level optimization problem.

In the structural optimal design device of Patent Document 1, the second evaluation functional of the second solving means is configured with a norm of a residual vector, and convergence determination in the calculation in the optimization problem of the second evaluation functional is determined by confirming that the square of the norm of the residual vector is smaller than a preset convergence determination threshold value.

### Citation List

### Patent Document

Patent Document 1: Japanese Patent Application Laid-open No. 2004-310375

### SUMMARY OF INVENTION

### Problems to Be Solved by Invention

In the optimal solution calculation device for an optimization problem as disclosed in Patent Document 1, convergence determination is performed on the basis of the magnitudes of a residual norm and a preset convergence determination threshold value. However, there is a problem that the convergence determination threshold value is not satisfied due to an influence of a calculation error contained in the residual vector, the error being caused by a rounding error or the like at the time of calculation, and a converged solution may not be obtained even if the iterative calculation is repeated.

An object of a technique disclosed in the present specification is to obtain a converged solution in a situation in which a calculation error contained in a residual vector affects calculation of a solution.

### Means for Solving Problems

An example of an optimal solution calculation device for an optimization problem disclosed in the present application is an optimal solution calculation device for an optimization problem that calculates a solution to an input optimization problem via processing by an update unit. The optimal solution calculation device for an optimization problem includes: an initial condition generation unit to acquire, as inputs, an inequality constraint set that is a set of inequality constraints with respect to the optimization problem, an evaluation function, and an initial solution, generate an executable initial solution that satisfies all inequality constraints in the inequality constraint set based on the initial solution, and generate an equality constraint set from the inequality constraint set with respect to the executable initial solution, the equality constraint set being a set of equality constraints where an equality sign holds; an optimization calculation unit to calculate a solution of a simultaneous linear equation generated from the equality constraint set and the evaluation function with respect to an input solution that is the executable initial solution for a first time or a solution updated by the update unit for a next time or late, and calculate an evaluated solution that minimizes or maximizes the evaluation function; and the update unit to determine the evaluated solution output by the optimization calculation unit, generate the equality constraint set updated by updating constraints to be satisfied by the evaluated solution from the equality constraint set, and generate the input solution updated based on the input solution and the evaluated solution that are previous solutions. The optimization calculation unit includes: an initial norm calculation unit to calculate an initial residual norm from an initial residual vector that is a difference between a vector of a left side of the simultaneous linear equation and a vector of a right side of the simultaneous linear equation with respect to the input solution; an iterative solution calculation unit to perform an iterative method, and calculate an iterative solution, the iterative solution being a solution for each iteration count of the simultaneous linear equation; a norm calculation unit to calculate a residual norm from a residual vector, the residual vector being a difference between the vector of the left side of the simultaneous linear equation and the vector of the right side of the simultaneous linear equation with respect to the iterative solution calculated by the iterative solution calculation unit; and a convergence determination unit to determine that the iterative solution has converged when the residual norm is equal to or less than a convergence determination threshold value, the convergence determination threshold value being a larger one of a preset first threshold value and a second threshold value set based on a relaxation parameter and the initial residual norm and output the iterative solution that has been determined to have converged as the evaluated solution. The update unit determines the evaluated solution as an optimal solution when an update of the equality constraint set is determined to be unnecessary, and the convergence determination threshold value is the first threshold value and outputs the optimal solution as an output solution that is a solution to the optimization problem.

### Effect of Invention

In an example of the optimal solution calculation device for an optimization problem disclosed in the present specification, the convergence determination unit determines that an iterative solution has converged when the residual norm is equal to or less than the convergence determination threshold value, which is the larger one of the preset first threshold value and the second threshold value set on the basis of the relaxation parameter and the initial residual norm, and outputs the iterative solution determined to have converged as the evaluated solution, and when an update of the equality constraint set is determined to be unnecessary and the convergence determination threshold value is the first threshold value, the update unit determines the evaluated solution as the optimal solution, so that a converged solution can be obtained in a situation where an calculation error contained in the residual vector affects the calculation of the solution.

### BRIEF DESCRIPTION OF DRAWINGS

FIG. 1 is a diagram showing a functional block in an optimal solution calculation device for an optimization problem according to Embodiment 1.

FIG. 2 is a diagram showing an example of a hardware configuration of the optimal solution calculation device for an optimization problem according to Embodiment 1.

FIG. 3 is a diagram showing a functional block of an evaluated solution calculation unit in FIG. 1.

FIG. 4 is a diagram showing an operation flow of the optimal solution calculation device for an optimization problem in FIG. 1.

FIG. 5 is a diagram showing an operation flow of an initial condition generation unit of FIG. 1.

FIG. 6 is a diagram showing an operation flow of an optimization calculation unit in FIG. 1.

FIG. 7 is a diagram showing an operation flow of the evaluated solution calculation unit of FIG. 3.

FIG. 8 is a diagram showing a first example of an operation flow in an update unit of FIG. 1.

FIG. 9 is a diagram showing a second example of an operation flow in the update unit of FIG. 1.

FIG. 10 is a diagram showing a third example of an operation flow in the update unit of FIG. 1.

FIG. 11 is a diagram showing a first example of a functional block in an optimal solution calculation device for an optimization problem according to Embodiment 2.

FIG. 12 is a diagram showing a second example of a functional block in an optimal solution calculation device for an optimization problem according to Embodiment 2.

### MODES FOR CARRYING OUT INVENTION

### Embodiment 1

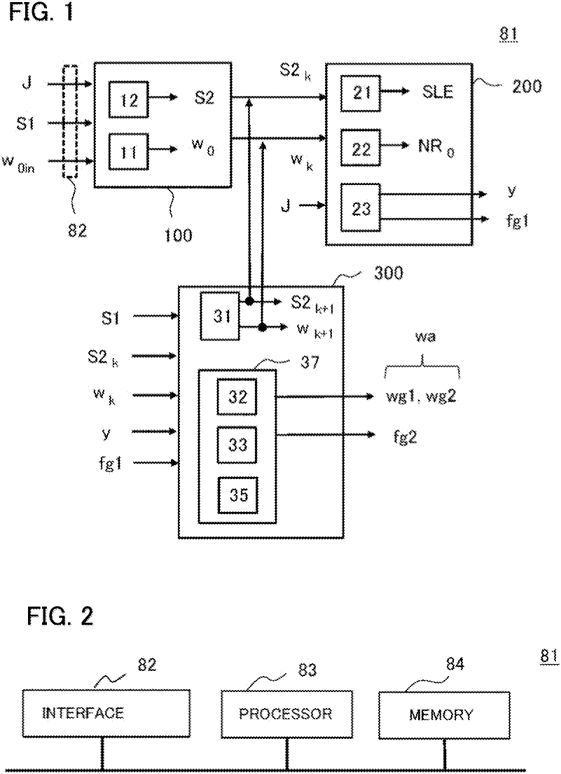

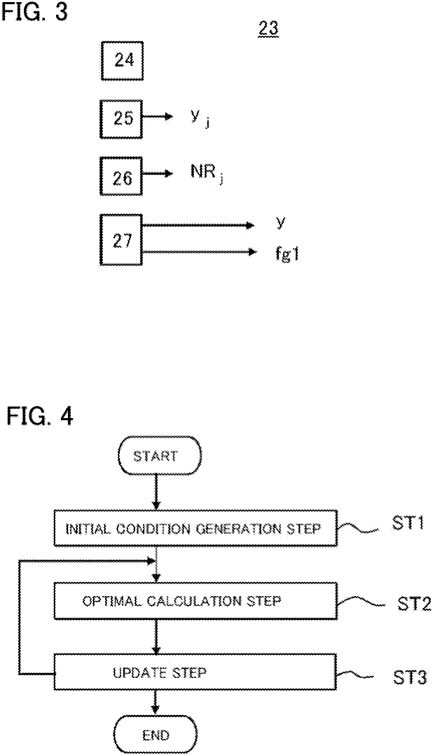

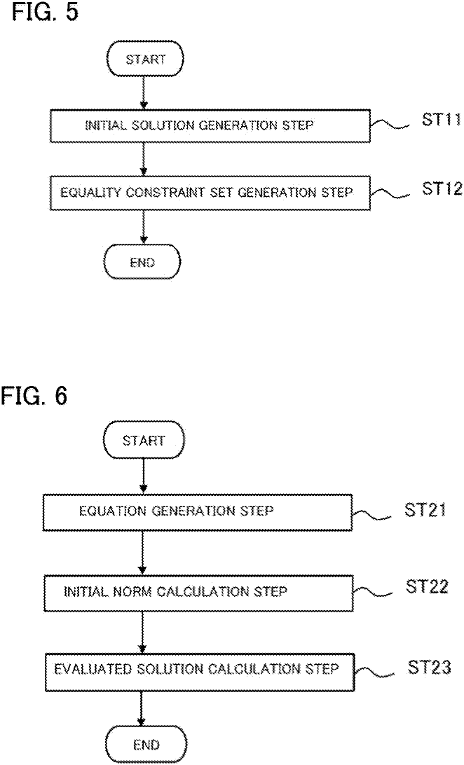

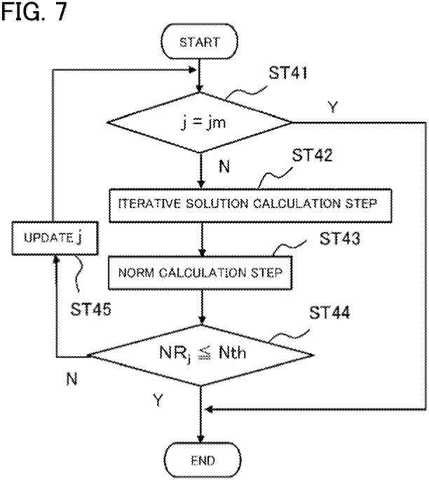

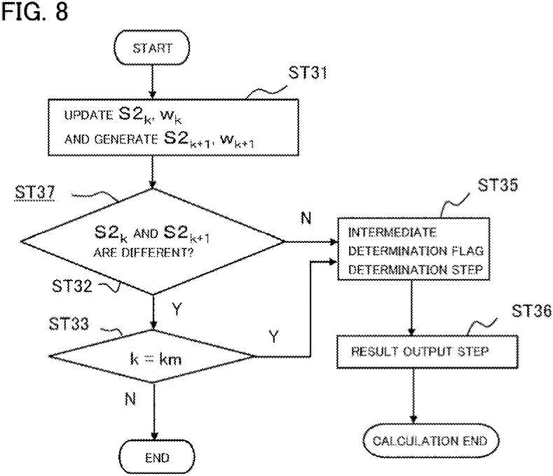

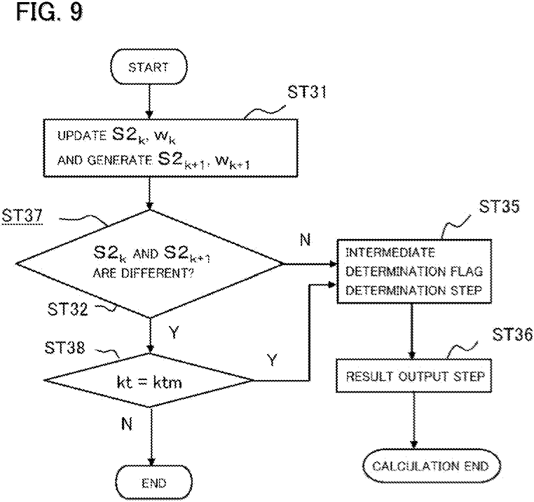

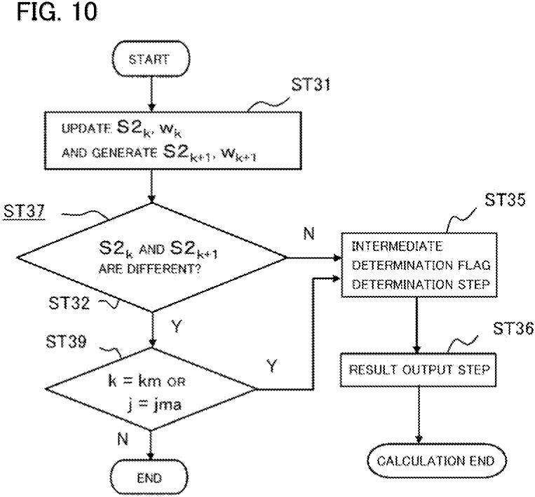

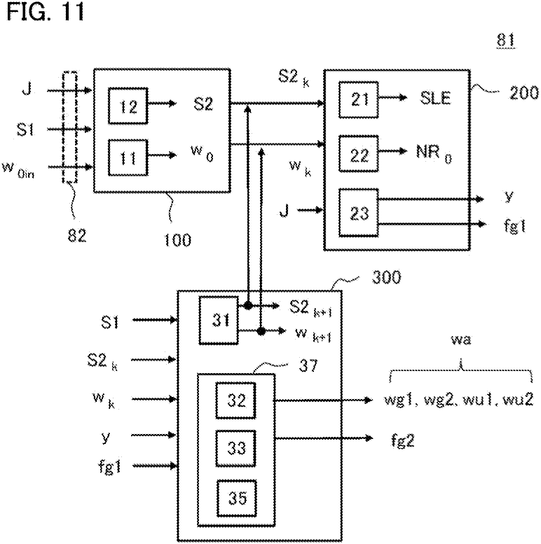

FIG. 1 is a diagram of a functional block in an optimal solution calculation device for an optimization problem according to Embodiment 1. FIG. 2 is a diagram showing an example of a hardware configuration of the optimal solution calculation device for an optimization problem according to Embodiment 1. FIG. 3 is a diagram showing a functional block of an evaluated solution calculation unit of FIG. 1. FIG. 4 is a diagram showing an operation flow of the optimal solution calculation device for an optimization problem in FIG. 1, FIG. 5 is a diagram showing an operation flow of an initial condition generation unit of FIG. 1, and FIG. 6 is a diagram showing an operation flow of an optimization calculation unit of FIG. 1. FIG. 7 is a diagram showing an operation flow of the evaluated solution calculation unit of FIG. 3, and FIG. 8 is a diagram showing a first example of an operation flow in an update unit of FIG. 1. FIG. 9 is a diagram showing a second example of an operation flow in the update unit of FIG. 1, and FIG. 10 is a diagram showing a third example of an operation flow in the update unit of FIG. 1. The optimal solution calculation device 81 for an optimization problem according to Embodiment 1 is implemented by a control unit incorporated in a device that needs to solve the optimization problem. For example, when an optimization problem related to a vehicle is to be solved, such as when an optimization problem for causing the vehicle to follow a target route is to be solved or when a problem for optimizing fuel consumption is to be solved, the optimal solution calculation device is installed in a control unit mounted on the vehicle. When an optimization problem for optimizing the operation of a factory is to be solved, it is mounted in a control unit mounted on a control device of the factory. As described above, the optimal solution calculation device 81 for an optimization problem according to an example disclosed in the specification of the present application is a device that calculates a solution to an optimization problem in a case where a target of the optimization problem is not limited, and various optimization problems are given.

FIG. 2 shows an example of a hardware configuration of the optimal solution calculation device 81 for an optimization problem. The optimal solution calculation device 81 for an optimization problem includes an interface 82 for acquiring various optimization problems and outputting calculation results of the acquired optimization problems, a processor 83 for calculating an optimal solution for an optimization problem, and a memory 84 for storing a program for solving an optimization problem, calculation data, and the like. A functional block of the optimal solution calculation device 81 for an optimization problem is implemented by the processor 83 executing the program stored in the memory 84. In addition, a plurality of processors 83 and a plurality of memories 84 may execute each function in cooperation with each other.

A functional block and an operation flow of the optimal solution calculation device 81 for an optimization problem according to Embodiment 1 will be described with reference to FIG. 1 and FIG. 4. Hereinafter, calculation of an optimal solution of an optimization problem for minimizing an evaluation function J will be described. The optimal solution calculation device for an optimization problem is simply referred to as an optimal solution calculation device as appropriate. Note that, in the case of the calculation for an optimal solution of an optimization problem in which the evaluation function J is maximized, the problem can be treated as an optimization problem in which the evaluation function J is minimized by multiplying the evaluation function J by -1 to invert the sign thereof. The optimal solution calculation device 81 includes an initial condition generation unit 100, an optimization calculation unit 200, and an update unit 300. The initial condition generation unit 100 generates input data containing an initial condition for calculating a solution of an optimization problem by iterative calculations of the optimization calculation unit 200 for a given optimization problem, that is, an inputted optimization problem. The optimization calculation unit 200 calculates an evaluated solution y that is a converged solution or a non-diverged solution on the basis of the input data containing the initial condition generated by the initial condition generation unit 100 or input data containing an update condition updated by the update unit 300. The evaluated solution y is at least a solution that does not diverge and contains a solution that approaches convergence but has reached an upper limit value for an iterative solution calculation count.

When there is a condition to be satisfied by the evaluated solution y calculated by the optimization calculation unit 200, the update unit 300 updates input data used by the optimization calculation unit 200 again, and outputs an output solution wa containing an optimal solution wg1 or a quasi-optimal solution wg2 when the evaluated solution y satisfies a determination condition. The optimal solution wg1 is a solution satisfying a preset first tolerance of the solution, and the quasi-optimal solution wg2 is a solution satisfying a preset second tolerance of the solution and is less strict than the first tolerance. The input data input to the optimization calculation unit 200 are a solution wₖ and an equality constraint set S2ₖ. The input data generated by the initial condition generation unit 100 are an executable initial solution w₀ and an initial equality constraint set S2. As appropriate, the input data containing the initial condition generated by the initial condition generation unit 100 is referred to as initial input data, and the input data containing the update condition updated by the update unit 300 is referred to as updated input data. The executable initial solution w₀ and the initial equality constraint set S2 are input to the optimization calculation unit 200 as the initial input data. At the time of the second and subsequent calculations, the solution wₖ and the equality constraint set S2ₖ are input to the optimization calculation unit 200 as the updated input data.

The optimal solution calculation device 81 executes an initial condition generation step of step ST1, an optimal calculation step of step ST2, and an update step of step ST3. In step ST1, the initial condition generation unit 100 of the optimal solution calculation device 81 generates the initial input data, namely, the executable initial solution w₀ and the initial equality constraint set S2 for the given optimization problem (initial condition generation step). In step ST2, the optimal solution calculation device 81 calculates at least a non-divergent evaluated solution y based on the initial input data generated in the initial condition generation step or the update input data updated in the update step of step ST3, namely, the solution wₖ and the equality constraint set S2ₖ (optimal calculation step). In step ST3, when there is a condition to be satisfied by the evaluated solution y calculated in the optimal calculation step, the optimal solution calculation device 81 updates the input data used in the calculation of the optimal calculation step again, and when the evaluated solution y satisfies the determination condition, the optimal solution calculation device 81 outputs the output solution wa containing the optimal solution wg1 or the quasi-optimal solution wg2 (update step).

The initial condition generation unit 100 acquires the evaluation function J of the optimization problem expressed by Equation (1), a set of inequality constraints expressed by Equation (2), that is, an inequality constraint set S1, and an initial solution w₀ᵢₙ as inputs of the optimization problem via the interface 82. The inequality constraint set S1, the evaluation function J, and the initial solution w₀ᵢₙ are input conditions for the optimization problem. In Equation (1), w is a solution vector and w^{T} is a transposed solution vector. H is a first condition matrix, and h^{T} is an adjustment row vector. C^{T} is a constraint matrix, and b is a constraint vector. Although Equation (2) is shown as an upper limit constraint, a lower limit constraint may be included. In the case of the lower limit constraint, by multiplying both sides of the constraint equation by -1 to invert the sign, the constraint equation can be handled as the upper limit constraint as shown in Equation (2).

$$J = \frac{1}{2} {w}^{T} H w + {h}^{T} w$$

$${C}^{T} w \leq b$$

A functional block and an operation flow of the initial condition generation unit 100 will be described with reference to FIG. 1 and FIG. 5. The initial condition generation unit 100 includes an initial solution generation unit 11 that generates the executable initial solution w₀, and an equality constraint set generation unit 12 that generates the equality constraint set S2 from the inequality constraint set S1. The initial condition generation unit 100 executes an initial solution generation step of step ST11 and an equality constraint set generation step in step ST12. The initial solution generation step of step ST11 is executed by the initial solution generation unit 11, and the equality constraint set generation step of step ST12 is executed by the equality constraint set generation unit 12. In step ST11, the initial solution generation unit 11 generates the executable initial solution w₀ (initial solution generation step). When the initial solution w₀ᵢₙ input to the initial condition generation unit 100 satisfies the inequality constraint set S1, the initial solution generation unit 11 sets the input initial solution w₀ᵢₙ as the executable initial solution w₀. When the initial solution w₀ᵢₙ does not satisfy the inequality constraint set S1 and is not executable, the initial solution generation unit 11 generates an executable initial solution w₀ that satisfies the inequality constraint set S1.

In step ST12, the equality constraint set generation unit 12 extracts only the constraints in which the equality sign holds in the inequality constraint set S1 with respect to the executable initial solution w₀ and generates the equality constraint set S2 that is a set of equality constraints as shown in Equation (3) (equality constraint set generation step).

$${A}_{0}^{T} {w}_{0} = b$$

The right side b of Equation (3) is the constraint vector in which an equal sign holds in the executable initial solution w₀. A^{T}0 is a constraint matrix when the executable initial solution w₀ satisfies the constraint vector b.

A functional block and an operation flow of the optimization calculation unit 200 will be described with reference to FIG. 1, FIG. 3, FIG. 6, and FIG. 7. The optimization calculation unit 200 acquires the evaluation function J of the optimization problem, the equality constraint set S2k, and the solution wₖ as inputs. Note that the subscript k of the solution wₖ and the equality constraint set S2ₖ corresponds to an iteration count of the optimization calculation unit 200, namely, the iteration count of the calculation, and k is 0 in the first calculation. In the first calculation, the solution wₖ and the equality constraint set S2ₖ are the executable initial solution w₀ and the equality constraint set S2, respectively. The optimization calculation unit 200 includes an equation generation unit 21 that generates a simultaneous linear equation SLE containing a Karush-Kuhn-Tucker condition (KKT condition), an initial norm calculation unit 22 that calculates an initial residual norm NR₀ being a norm of an initial residual vector rᵢₙ, and the evaluated solution calculation unit 23 that calculates at least the non-divergent evaluated solution y and generates an intermediate determination flag fg1. The intermediate determination flag fg1 is a flag indicating a first convergent solution or a second convergent solution, the first convergent solution satisfying the preset first tolerance of the solution, the second convergent solution not satisfying the preset first tolerance of the solution but satisfying the preset second tolerance of the solution. The optimization calculation unit 200 executes an equation generation step of step ST21, an initial norm calculation step of step ST22, and an evaluated solution calculation step of step ST23. The equation generation step of step ST21 is executed by the equation generation unit 21, the initial norm calculation step of step ST22 is executed by the initial norm calculation unit 22, and the evaluated solution calculation step of step ST23 is executed by the evaluated solution calculation unit 23.

The evaluated solution calculation unit 23 includes a calculation count determination unit 24 that determines whether the iterative solution calculation count j has reached an upper limit jm of the iterative solution calculation count, an iterative solution calculation unit 25 that calculates an iterative solution yⱼ, a norm calculation unit 26 that calculates a residual norm NRⱼ, which is a norm of a residual vector rⱼ, and a convergence determination unit 27 that determines convergence of the iterative solution yⱼ and generates the evaluated solution y and the intermediate determination flag fg1. The evaluated solution calculation unit 23 executes step ST41 to step ST45 as the evaluated solution calculation step of step ST23. An iterative solution calculation count determination step of step ST41 and an iterative solution calculation count update step of step ST45 are executed by the calculation count determination unit 24. An iterative solution calculation step of step ST42 is executed by the iterative solution calculation unit 25, a norm calculation step of step ST43 is executed by the norm calculation unit 26, and a convergence determination step of step ST44 is executed by the convergence determination unit 27.

In this case, since the optimal solution calculation device 81 solves a minimization problem of the evaluation function J with only the equality constraints as the constraints, the simultaneous linear equation SLE for solving the minimization problem of the evaluation function J with only the equality constraints as the constraints are generated in step ST21 (equation generation step). The minimization problem of the evaluation function J with only the equality constraints as the constraints is expressed by Equation (4). In the equation generation step of step ST21, the simultaneous linear equation SLE containing the Karush-Kuhn-Tucker condition (KKT condition) is generated as shown in Equation (5). In Equation (5), y is the evaluated solution of the minimization problem represented by Equation (4) when the calculation iteration count is k, and λ is a Lagrange multiplier corresponding to each constraint, and h is an adjustment column vector and is in a transposed relationship with the adjustment row vector h^{T}. Aₖ is a constraint matrix when the calculation iteration count is k, and A^{T}ₖ is a transposed matrix of the constraint matrix Aₖ, and bₖ is a constraint vector when the calculation iteration count is k. Note that a converged evaluated solution y among the evaluated solutions y generated by the evaluated solution calculation unit 23 can also be referred to as a converged solution containing an optimal solution of the minimization problem when the calculation iteration count is k. When a calculation determination unit 37 of the update unit 300 determines that the converged evaluated solution y is an optimal solution, the converged evaluated solution y is the optimal solution of the minimization problem represented by Equation (4).

$$\begin{matrix}{min}_{w} J = \frac{1}{2} {w}^{T} H w + {h}^{T} w \\ \text{s} \text{.t} \text{.} {A}_{k}^{T} w = b\end{matrix}$$

$$\left[\begin{matrix}H & {A}_{k} \\ {A}_{k}^{T} & 0\end{matrix}\right] \left[\begin{matrix}y \\ λ\end{matrix}\right] = \left[\begin{matrix}- h \\ {b}_{k}\end{matrix}\right]$$

Here, the subscript k corresponds to the calculation iteration count of the optimization calculation unit 200 as described above. The evaluated solution y generated by the evaluated solution calculation unit 23 becomes a solution wₖ₊₁ updated by the update unit 300. The solution wₖ₊₁ becomes the solution wₖ to be input to the optimization calculation unit 200 at the updated calculation iteration count k.

In the following description, Equation (6) obtained by simplifying the notation of the simultaneous linear equation SLE shown in Equation (5) is used. A matrix on the left side in Equation (5), that is, the constraint matrix, is denoted by A^{∼}, the column vector containing y on the left side is denoted by x, and the column vector containing bₖ on the right side, that is, the constraint vector, is denoted by b^{~}.

$$\tilde{A} x = \tilde{b}$$

In step ST22, the initial norm calculation unit 22 calculates the initial residual norm NR₀ expressed by Equation (7), which is the norm of the initial residual vector rᵢₙ in the simultaneous linear equation SLE for the solution wₖ, namely, the input solution, acquired as the input by the optimization calculation unit 200. The initial residual vector rᵢₙ is expressed by an equation caught between symbols “||” on the rightmost side of Equation (7). The initial residual vector rᵢₙ is the difference between the vector on the left side of the simultaneous linear equation SLE and the vector on the right side of the simultaneous linear equation SLE for the solution wₖ. Aₖ^{∼} is the constraint matrix A^{∼} at the calculation iteration count k, and bₖ^{∼} is the constraint vector b^{∼} at the calculation iteration count k.

$$N {R}_{0} = \left|\left|{r}_{i n}\right|\right| = \left|\left|{\tilde{A}}_{k} {w}_{k} - {\tilde{b}}_{k}\right|\right|$$

In step ST23, the evaluated solution calculation unit 23 executes the iterative solution calculation step multiple times and calculates to solve the simultaneous linear equation SLE using the iterative method, thereby calculating the evaluated solution y that is a solution that minimizes the evaluation function J, namely, a converged solution or a non-diverged solution (evaluated solution calculation step). The evaluated solution calculation step of step ST23 will be described in detail. In step ST41, the calculation count determination unit 24 determines whether the iterative solution calculation count j of the optimization calculation unit 200 has reached the preset upper limit value jm of the iterative solution calculation count (iterative solution calculation count determination step). In step ST41, when the iterative solution calculation count j has reached the upper limit value jm of the iterative solution calculation count, the process ends, and when the iterative solution calculation count j has not reached the upper limit value jm of the iterative solution calculation count, the process proceeds to step ST42. In step ST42, the iterative solution calculation unit 25 performs an iterative solution calculation step and calculates a solution that minimizes the evaluation function J, namely, the iterative solution yⱼ by solving the simultaneous linear equation SLE using the iterative method (iterative solution calculation step). The iterative solution calculation count j will be described later.

As the iterative method for solving the simultaneous linear equation SLE, a method using a Krylov subspace method such as a conjugate gradient (CG) method or a generalized minimal residual (GMRES) method is known. Before the iterative method is performed, the simultaneous linear equation SLE may be pre-processed in order to improve numerical convergence and stability. Details on the iterative method using the Krylov subspace method and the preprocessing for the simultaneous linear equation SLE are described in “Mathematics of Iterative Method” written by Kiyoshi Fujitsugu and ZHANG Shao-Liang, Asakura Publishing Co., Ltd., 1996, or “Numerical Analysis 2nd Edition” written by Masatake Mori, Kyoritsu Mathematics Course 12, 2002.

In step ST43, the norm calculation unit 26 calculates the residual norm NRⱼ as shown in Equation (8), which is the norm of the residual vector rⱼ in the simultaneous linear equation SLE with respect to the iterative solution yⱼ calculated in the iterative solution calculation step of step ST42 (norm calculation step). The residual vector rⱼ is expressed by an equation caught between symbols “||” on the rightmost side of Equation (8). The residual vector rⱼ is the difference between the vector on the left side of the simultaneous linear equation SLE and the vector on the right side of the simultaneous linear equation SLE with respect to the iterative solution yⱼ.

Here, the subscript j indicates the iteration count of the calculation for solving the simultaneous linear equation SLE, namely, the iterative solution calculation count, the calculation being performed in the iterative solution calculation step of step ST42. This count is different from the calculation iteration count k indicating the iteration count of the optimization calculation unit 200. In the k-th iteration of the optimization calculation unit 200, the iterative solution calculation of the iterative solution calculation step of step ST42 is performed j times.

$$N {R}_{j} = \left|\left|{r}_{j}\right|\right| = \left|\left|{\tilde{A}}_{k} {y}_{j} - {\tilde{b}}_{k}\right|\right|$$

In step ST44, the convergence determination unit 27 determines whether the iterative solution yⱼ has converged (convergence determination step). To be specific, for the solution obtained by the j-th iterative solution calculation in step ST42, namely, the iterative solution yⱼ, the convergence determination unit 27 determines whether or not the residual norm NRⱼ that is the norm of the residual vector rⱼ in the simultaneous linear equation SLE with respect to the iterative solution yⱼ obtained by the norm calculation unit 26 is equal to or less than a convergence determination threshold value Nth. In step ST44, when the residual norm NRj is equal to or less than the convergence determination threshold value Nth, the convergence determination unit 27 determines that the solution of the simultaneous linear equation SLE is obtained, outputs the converged iterative solution yⱼ as the converged evaluated solution y and ends the process. In step ST44, when the residual norm NRⱼ is not equal to or smaller than the convergence determination threshold value Nth, namely, when the residual norm NRⱼ is larger than the convergence determination threshold value Nth, the process returns to step ST41 via step ST45. The calculation count determination unit 24 updates the iterative solution calculation count j by incrementing it by one in step ST45 (iterative solution calculation count update step) and executes the iterative solution calculation count determination step of step ST41.

When the iterative solution yⱼ converges, the optimization calculation unit 200 outputs the converged iterative solution yⱼ as the converged evaluated solution y. When the iterative solution yⱼ does not converge before the iterative solution calculation count j reaches the upper limit value jm of the iterative solution calculation count, the optimization calculation unit 200 outputs the iterative solution yⱼ that does not converge as the evaluated solution y that does not diverge. Note that the converged iterative solution yⱼ can be obtained by appropriately setting a relaxation parameter m, which will be described later, and by setting a sufficiently large upper limit value jm of the iterative solution calculation count. Even if the iterative solution yⱼ does not converge before the iterative solution calculation count j reaches the upper limit value jm of the iterative solution calculation count, by appropriately setting the relaxation parameter m and by repeating the optimal calculation step of step ST2 with the data update by the update unit 300, the residual norm NRⱼ becomes small and the converged iterative solution yⱼ can be obtained. Note that, when an upper limit value km of the calculation iteration count and the upper limit value jm of the iterative solution calculation count which are upper limit values of the calculation iteration count k and the iterative solution calculation count j count cannot be set to sufficiently large values, a converged solution may not be obtained. In this case, the result is treated as no solution in a result output step of step ST36 described below.

A preset first threshold value Nt1 from the tolerance of the solution and a second threshold value Nt2 are compared, the second threshold value Nt2 being set on the basis of the relaxation parameter m and the initial residual norm NR₀ calculated in the initial norm calculation step of step ST22, and then the convergence determination threshold value Nth used in the convergence determination step of step ST44 is set to the larger value thereof. That is, the convergence determination threshold value Nth is either the preset first threshold value Nt1 or the second threshold value NR2 set on the basis of the relaxation parameter m and the initial residual norm NR₀ and is the larger one. The second threshold value Nt2 is set as in the following Equation (9).

$$\left|\left|{r}_{i n}\right|\right| / m$$

By setting the convergence determination threshold value Nth to the larger one of the first threshold value Nt1 and the second threshold value Nt2, since a solution can be obtained by performing the convergence determination using the first threshold value Nt1 in the convergence determination step of step ST44 in the case where the initial residual norm NR₀ is small, the solution with accuracy within the preset first tolerance can be obtained in the evaluated solution calculation step of step ST23. The solution for which the convergence determination is performed using the first threshold value Nt1 is a sufficiently optimized solution and can be the output solution wa indicating the optimal solution via the process of the update unit 300. On the other hand, when the initial residual norm NR₀ is large, a solution obtained by performing the convergence determination using the second threshold value Nt2 in the convergence determination step of step ST44 can be obtained. The solution for which the convergence determination is performed using the second threshold value Nt2 is a quasi-optimized solution that exceeds the preset first tolerance but satisfies the preset second tolerance of the solution and can be the output solution wa indicating the quasi-optimal solution via the process of the update unit 300. As a result, it is possible to prevent problems in which the residual vector rⱼ or the iterative solution yⱼ diverges in the iterative solution calculation step of step ST42 due to the influence of numerical errors such as a loss of significant digits from the insufficient number of significant digits and the evaluated solution y that does not diverge cannot be obtained in the evaluated solution calculation step of step ST23.

In solving of the simultaneous linear equation SLE using the iterative method, a solution at the next iteration is calculated using the residual vector rⱼ with respect to the iterative solution yⱼ, namely, the calculated solution. In the case where the initial residual norm NR₀, which is the norm of the initial residual vector rᵢₙ calculated for the first time, is large, and the residual norm NRj, which is the norm of the residual vector rⱼ calculated next, drastically decreases, the number of significant digits of the variable indicating the residual vector rⱼ may be insufficient, and the next solution may not be appropriately calculated. Since the second threshold value Nt2 is set by using the initial residual norm NR₀ and the relaxation parameter m considering the number of significant digits of the variable used for the calculation, it is possible to perform the convergence determination before the influence of numerical errors of the residual norm NRⱼ becomes large.

The relaxation parameter m is set to 10² to 10⁴ as a first range E1 when a calculation is performed using a single-precision type variable as each variable in the optimization calculation unit 200. In addition, the relaxation parameter m is set to 10⁸ to 10¹² as a second range E2 when the calculation is performed using a double-precision type variable. By setting an appropriate value to the value of the relaxation parameter m, it is possible to secure the sufficient number of significant digits for variables such as the iterative solution yⱼ calculated in the iterative solution calculation step of step ST42 and the residual vector rⱼ calculated in the norm calculation step of step ST43. When the number of significant digits is sufficient, the optimal solution calculation device 81 repeats the evaluated solution calculation step of step ST23 as usual and performs the convergence determination using the first threshold value Nt1 in the convergence determination step of step ST44, thereby obtaining a solution with accuracy within the preset tolerance by the optimization calculation unit 200. In addition, in the case where there is a possibility that the iterative solution yⱼ calculated in the iterative solution calculation step of step ST42 and the residual vector rⱼ calculated in the norm calculation step of step ST43 are not appropriate owing to numerical errors increased caused by a loss of significant digits from the insufficient number of significant digits or the like, the optimal solution calculation device 81 can prevent the possibility that the iterative solution yⱼ and the residual vector rⱼ are not appropriate by performing the convergence determination using the second threshold value Nt2 in the convergence determination step of step ST44.

In the case where the value of the relaxation parameter m is smaller than that in the first range E1 or the second range E2, even in the case where the number of significant digits of the variable is sufficient in the iterative solution calculation step of step ST42, the influence of numerical errors is small, and the calculation can be performed with high accuracy, a case occurs in which the convergence determination is performed not by the preset first threshold value Nt1 from the tolerance of the solution but by the second threshold value Nt2 in the convergence determination step of step ST44. In this case, the accuracy of the evaluated solution y output from the optimization calculation unit 200 decreases. In addition, in the case where the value of the relaxation parameter m is larger than that in the first range E1 or the second range E2, numerical errors due to a loss of significant digits from the insufficient number of significant digits or the like become large, and a case occurs in which it is not determined that convergence has occurred in the convergence determination step of step ST44. Since the convergence is not determined in the convergence determination step of step ST44, the evaluated solution y is output as an iteration upper limit calculation solution in which the iterative solution calculation count j exceeds the upper limit value jm of the iterative solution calculation count. In this case, the update unit 300 updates the evaluated solution y to the solution wₖ₊₁, the updated equality constraint set S2ₖ+₁ and the solution wₖ₊₁ are input to the optimization calculation unit 200, and the calculation process of the optimization calculation unit 200, namely, the optimal calculation step of step ST2 is executed again. In this case, the iterative solution yⱼ in the iterative solution calculation in step ST42 and the residual vector rⱼ calculated in the norm calculation step of step ST43 are not appropriate, the solution of the simultaneous linear equation SLE is not obtained, and the intended effect is not obtained. Note that, if the value of the relaxation parameter m falls within the first range E1 or the second range E2, a converged evaluated solution y can be obtained by setting an upper limit value jm of the iterative solution calculation count with a sufficient count.

In the convergence determination step of step ST44, when the convergence determination is performed using the first threshold value Nt1 as the convergence determination threshold value Nth, the evaluated solution calculation unit 23 outputs the intermediate determination flag fg1 indicating that the evaluated solution y satisfies the preset first tolerance of the solution. In addition, in the convergence determination step of step ST44, when the convergence determination is performed using the second threshold value Nt2 as the convergence determination threshold value Nth, the evaluated solution calculation unit 23 outputs the intermediate determination flag fg1 indicating that the evaluated solution y satisfies the preset second tolerance of the solution. The solution satisfying the first tolerance is the first convergent solution, and the solution satisfying the second tolerance is the second convergent solution. For example, in the case where the intermediate determination flag fg1 is a 2-bit signal, when the intermediate determination flag fg1 is 3, it can indicate the first convergent solution, and when the intermediate determination flag fg1 is 2, it can indicate the second convergent solution.

A functional block and an operation flow of the update unit 300 will be described with reference to FIG. 1 and FIG. 8. The update unit 300 includes a data update unit 31 that updates the equality constraint set S2ₖ and the solution wₖ and generates the updated equality constraint set S2ₖ+₁ and the solution wₖ₊₁, and the calculation determination unit 37 that determines the solution wₖ₊₁ to generate the output solution wa satisfying the determination condition and a determination flag fg2. The calculation determination unit 37 includes a set update determination unit 32 that determines whether the equality constraint set S2ₖ has been updated, an update count determination unit 33 that determines whether the calculation iteration count k has reached the upper limit value km of the calculation iteration count, and a result output unit 35 that generates the output solution wa satisfying the determination condition and the determination flag fg2. The update unit 300 executes a data update step of step ST31 and a calculation determination step of step ST37. The calculation determination step of step ST37 includes a set update determination step of step ST32, an update count determination step of step ST33, an intermediate determination flag determination step of step ST35, and the result output step of step ST36. The data update step of step ST31 is executed by the data update unit 31, and the calculation determination step of step ST37 is executed by the calculation determination unit 37. The set update determination step of step ST32 is executed by the set update determination unit 32, and the update count determination step of step ST33 is executed by the update count determination unit 33. The intermediate determination flag determination step of step ST35 and the result output step of step ST36 are executed by the result output unit 35.

The update unit 300 acquires, as inputs, the inequality constraint set S1, the equality constraint set S2ₖ, the solution wₖ input to the optimization calculation unit 200, the evaluated solution y generated by the optimization calculation unit 200, and the intermediate determination flag fg1. In the data update step of step ST31, the equality constraint set S2ₖ and the solution wₖ input to the optimization calculation unit 200 are updated, and an updated equality constraint set S2ₖ+₁ and a solution wₖ₊₁ are output. The optimization calculation unit 200 uses the equality constraint set S2ₖ+₁ and the solution wₖ₊₁ as the equality constraint set S2ₖ and the solution wₖ to be input when performing (k+1)-th calculation. The equality constraint set S2ₖ+₁ and the solution wₖ₊₁ are determined as follows.

(a) Update method when there is a constraint to be added to the equality constraint set S2ₖ (update method 1)

In step ST31, when the evaluated solution y obtained by the optimization calculation unit 200 does not satisfy one or more constraints in the inequality constraint set S1, the data update unit 31 determines the solution wₖ₊₁ output by the update unit 300 using Equation (10). Here, a is set to the largest value under the condition that 0 < a < 1 and wₖ₊₁ satisfies the inequality constraint set S1. Further in step ST31, the update unit 31 generates the updated equality constraint set S2ₖ+₁ by adding a constraint that newly satisfies an equality constraint with respect to the wₖ₊₁, to the equality constraint set S2ₖ.

$${w}_{k + 1} = \left(1 - α\right) {w}_{k} + α y$$

(b) Update method when there is a constraint to be removed in the equality constraint set S2ₖ (update method 2).

In step ST31, when the evaluated solution y obtained by the optimization calculation unit 200 satisfy all the constraints within the inequality constraint set S1, the data update unit 31 determines the solution wₖ₊₁ output by the update unit 300 using Equation (11). Further, in step ST31, when there is an evaluated solution y obtained by the optimization calculation unit 200 that satisfies the Lagrange multiplier λ < 0, the update unit 31 removes a constraint corresponding to a solution having the largest absolute value from the equality constraint set S2ₖ to generate the updated equality constraint set S2ₖ₊₁.

$${w}_{k + 1} = y$$

In the data update step of step ST31, the data update unit 31 updates the equality constraint set S2ₖ and the solution wₖ by the update method 1 or the update method 2 and generates the updated equality constraint set S2ₖ+₁ and the updated solution wₖ₊₁. When the equality constraint set S2ₖ is not updated in the data update step of step ST31, namely, when no constraint is added to the equality constraint set S2ₖ and no constraint is removed from the equality constraint set S2ₖ, the evaluated solution y obtained by the optimization calculation unit 200 satisfies the inequality constraint set S1 and is the optimal solution that minimizes the evaluation function J input to the optimal solution calculation device 81. Therefore, the optimal solution calculation device 81 ends the calculation, and outputs the evaluated solution y as the output solution wa of the optimal solution. This is an outline of part of the processing of the calculation determination step of step ST37. When the output solution wa is output, the calculation of the optimal solution calculation device 81 ends. That is, when the output solution wa is output, it is the calculation end shown in FIG. 8, and it is the end shown in FIG. 4. When the output solution wa is output, it is a complete end, and when the condition is not satisfied in step ST33 and the equality constraint set S2ₖ+₁ and the solution wₖ₊₁ that are update data are output, it is an update end. In the case of the update end, the optimal solution calculation device 81 returns to step ST2 and executes the optimization calculation process. The calculation determination step of step ST37 will be described in detail.

In the set update determination step of step ST32, the set update determination unit 32 determines whether the equality constraint set S2ₖ has been updated, to be specific, whether the equality constraint set S2ₖ and the equality constraint set S2ₖ+₁ are different. When the equality constraint set S2ₖ and the equality constraint set S2ₖ+₁ are different, the process proceeds to step ST33, and when the equality constraint set S2ₖ and the equality constraint set S2ₖ+₁ are not different, namely, equal, the process proceeds to step ST35.

In the update count determination step of step ST33, the update count determination unit 33 determines whether or not the calculation iteration count k reaches the upper limit value km of the calculation iteration count that is preset. If the calculation iteration count k has reached the upper limit value km of the calculation iteration count, the process proceeds to step ST35. If the calculation iteration count k has not reached the upper limit value km of the calculation iteration count, the update unit 300 outputs the equality constraint set S2ₖ+₁ and the solution wₖ₊₁ generated by the data update unit 31 to the optimization calculation unit 200 and ends the update step of step ST3. As described above, the end in this case is the update end. If the calculation iteration count k has reached the upper limit value km of the calculation iteration count, the optimal solution calculation device 81 determines that the iteration upper limit has been reached and ends the calculation. If the calculation iteration count k has reached the upper limit value km of the calculation iteration count, it can be said that the update count of the equality constraint set S2ₖ has reached the upper limit value. In this case, it is the complete end.

In the intermediate determination flag determination step of step ST35, when the process proceeded from the set update determination step of step ST32, the result output unit 35 determines the information of the intermediate determination flag fg1. When the intermediate determination flag fg1 indicates the first convergent solution, the result output unit 35 generates the determination flag fg2 indicating the optimal solution. Further, when the intermediate determination flag fg1 indicates the second convergent solution, the result output unit 35 generates the determination flag fg2 indicating the quasi-optimal solution. As described above, the evaluated solution y satisfying the preset first tolerance of the solution is a fully optimized solution, namely, the optimal solution. In addition, the evaluated solution y satisfying the preset second tolerance of the solution is a quasi-optimized solution, namely, the quasi-optimal solution. To be more specific, the evaluated solution y when the convergence determination threshold value Nth in the convergence determination step of step ST44 is the first threshold value Nt1 is the optimal solution, and the evaluated solution y when the convergence determination threshold value Nth in the convergence determination step of step ST44 is the second threshold value Nt2 is the quasi-optimal solution. For example, in the case where the determination flag fg2 is a 2-bit signal, if the determination flag fg2 is 3, it can indicate an optimal solution, and if the determination flag fg2 is 2, it can indicate a quasi-optimal solution.

In the intermediate determination flag determination step of step ST35, when the process proceeded from the update count determination step of step ST33, the result output unit 35 outputs the determination flag fg2 indicating no solution in the result output step of step ST36 without determining the information of the intermediate determination flag fg1. In this case, the normal output solution wa is not output. For example, the determination flag fg2 indicating no solution is 1. In this case, the normal output solution wa is not output, but for example, zero (0) may be output as null data.

In the result output step of step ST36, when the process proceeded from the set update determination step of step ST32, the result output unit 35 outputs the output solution wa and the determination flag fg2. When the intermediate determination flag fg1 indicates the first convergent solution, the evaluated solution y is output as the output solution wa of the optimal solution, namely, the optimal solution wg1, and the determination flag fg2 indicating the optimal solution is output. When the intermediate determination flag fg1 indicates the second convergent solution, the evaluated solution y is output as the output solution wa of the quasi-optimal solution, namely, the quasi-optimal solution wg2, and the determination flag fg2 indicating the quasi-optimal solution is output. The optimal solution wg1 and the quasi-optimal solution wg2 output as the output solution wa are converged solutions. It can also be said that the optimal solution wg1 is a solution output as the output solution wa for a solution to the optimization problem when the evaluated solution y is determined to be the optimal solution in the case where the update of the equality constraint set is determined to be unnecessary in the set update determination step of step ST32 and the convergence determination threshold value Nth is the first threshold value Nt1. It can also be said that the quasi-optimal solution wg2 is a solution output as the output solution wa for a solution to the optimization problem when the evaluated solution y is determined to be the quasi optimal solution and the evaluated solution y is not determined as the optimal solution wg1 in the case where the update of the equality constraint set is determined to be unnecessary in the set update determination step of step ST32 and the convergence determination threshold value Nth is the second threshold value Nt2.

As described above, the optimal solution calculation device 81 for an optimization problem in Embodiment 1 repeatedly updates the equality constraint set S2ₖ and the solution wₖ in the update unit 300 using the evaluated solution y calculated in the optimization calculation unit 200 and obtains an optimal solution or a quasi-optimal solution that minimizes the evaluation function J. Therefore, even when the initial residual norm NR₀ that is calculated on the basis of the executable initial solution w₀ generated by the initial condition generation unit 100 and the residual norm NRⱼ are large, by setting a sufficiently large upper limit jm of the iterative solution calculation count, the optimization calculation unit 200 can output the evaluated solution y to which convergence determination is performed by using the second threshold value Nt2 in the convergence determination step of step ST44, namely, the evaluated solution y converged by using the second threshold value Nt2, to the update unit 300. In addition, the optimal solution calculation device 81 for an optimization problem in Embodiment 1 updates the equality constraint set S2ₖ and the solution wₖ on the basis of the evaluated solution y output from the optimization calculation unit 200 and executes the optimization calculation step of step ST2 again by the optimization calculation unit 200. That is, even when the initial residual norm NR₀ that is calculated on the basis of the executable initial solution w₀ and the residual norm NRⱼ are large, the optimal solution calculation device 81 for an optimization problem in Embodiment 1 generates a new simultaneous linear equation SLE by the optimization calculation unit 200 and performs calculation to solve the simultaneous linear equation SLE again.

By repeating the optimization calculation step of step ST2 and the update step of step ST3, the initial residual norm NR₀ and the residual norm NRⱼ calculated on the basis of the solution wₖ input to the optimization calculation unit 200 become smaller, and the optimization calculation unit 200 can output the evaluated solution y to which convergence determination is performed by using the first threshold value Nt1 in the convergence determination step of step ST44, namely, the evaluated solution y converged by using the first threshold value Nt1, to the update unit 300. Therefore, the optimal solution calculation device 81 for an optimization problem in Embodiment 1 repeats the optimization calculation step of step ST2 and the update step of step ST3, thereby easily obtaining a converged solution by using the first threshold value Nt1, namely, an optimal solution having accuracy within the preset tolerance.

That is, before the influence of the calculation errors on the initial residual vector rᵢₙ and the residual vector rⱼ becomes large, the optimal solution calculation device 81 of Embodiment 1 performs the convergence determination using the second threshold value Nt2, and the optimization calculation unit 200 executes the optimization calculation step of step ST2 again using the evaluated solution y at that time. Thus, the optimal solution calculation device 81 of Embodiment 1 can reduce the initial residual norm NR₀ calculated in the initial norm calculation step of step ST22 at the time of the optimization calculation step of step ST2 to be executed again. This means that the solution wₖ, which is the input initial solution at the time of recalculation, is close to the optimal solution, and the influence of calculation errors on the initial residual vector rᵢₙ and the residual vector rⱼ becomes small, so that a converged solution using the first threshold value Nt1, namely, an optimal solution with accuracy within the preset tolerance, can be easily obtained. In addition, at the time of the optimization calculation step of step ST2 to be executed again, since the second threshold value Nt2 is also set to be small even when the second threshold value Nt2 is to be used, the optimal solution calculation device 81 for an optimization problem in Embodiment 1 obtains a solution through convergence determination using the first threshold value Nt1 by repeating the calculation.

As described above, when an equality constraint is not added to or removed from the equality constraint set S2ₖ in the set update determination step of step ST32, the update unit 300 outputs the evaluated solution y obtained by the optimization calculation unit 200 as the output solution wa of the optimal solution that satisfies the whole inequality constraint set S1 and minimizes the evaluation function J. The output solution wa contains an optimal solution wg1 when the convergence determination threshold value Nth is the first threshold value Nt1 in the convergence determination step of step ST44, and a quasi-optimal solution wg2 when the convergence determination threshold value Nth is the second threshold value Nt2 in the convergence determination step of step ST44. Regarding the quasi-optimal solution wg2, the residual norm NRⱼ of the simultaneous linear equation SLE is larger than the first threshold value Nt1 set from the preset tolerance of the solution, but the update unit 300 outputs the determination flag fg2 indicating the quasi-optimal solution, so that it can be known that the output solution wa obtained by the optimal solution calculation device 81 is the solution that does not satisfy the accuracy within the preset tolerance of the solution, namely, the accuracy within the first tolerance of the solution.

Regarding the solution wa output by the optimal solution calculation device 81 for an optimization problem, when the determination flag fg2 indicating the quasi-optimal solution is obtained, the device provided with the optimal solution calculation device 81 for an optimization problem in Embodiment 1 that needs to solve the optimization problem can confirm whether or not to adopt the output solution wa.

The optimal solution calculation device 81 for an optimization problem in Embodiment 1 can perform the convergence determination of the evaluated solution y before the calculation error of the residual vector rⱼ affects the calculation of the optimal solution. That is, the optimal solution calculation device 81 for an optimization problem in Embodiment 1 can obtain a converged solution as the output solution wa in a situation in which the calculation error contained in the residual vector rⱼ affects the calculation of the optimal solution.

Note that the optimal solution calculation device 81 for an optimization problem in Embodiment 1 has been described for an optimization problem including the inequality constraint. Even when the constraints of the optimization problem are only the equality constraints, the optimal solution calculation device 81 for an optimization problem in Embodiment 1 can determine the convergence of the evaluated solution y before the calculation error of the residual vector rⱼ affects the calculation of the optimal solution. That is, even when the constraints of an optimization problem are only the equality constraints, the optimal solution calculation device 81 for an optimization problem in Embodiment 1 can obtain a converged solution in a situation where the calculation error contained in the residual vector affects the calculation of the optimal solution. In this case, the input data input to the optimization calculation unit 200 is the executable initial solution w₀ and the equality constraint set S2 input via the interface 82. In addition, the equality constraint set generation unit 12 of the initial condition generation unit 100, the data update unit 31, the set update determination unit 32, and the update count determination unit 33 of the update unit 300 are unnecessary. Note that, if the result output unit 35 is included in the optimization calculation unit 200, the update unit 300 is unnecessary.

Further, in the optimal solution calculation device 81 for an optimization problem in Embodiment 1, an example in which the update unit 300 executes the first example of the operation flow illustrated in FIG. 8 has been described. However, the update count determination step of step ST33 is not limited to the case of using only the calculation iteration count k. For example, the iterative solution calculation count j for solving the simultaneous linear equation SLE executed in the evaluated solution calculation step of step ST23 may be considered. For example, the update or the calculation may be ended when a calculation total count kt, which is the sum of the calculation iteration count k and the iterative solution calculation count j, reaches an upper limit value ktm of the total calculation count. FIG. 9 shows a second example of the operation flow in the update unit 300 in which the above change is reflected. In addition, the upper limit value of the iteration count may be set for each of the calculation iteration count k and the iterative solution calculation count j to perform monitoring. FIG. 10 shows a third example of the operation flow in the update unit 300 in which the above change is reflected. When the update unit 300 executes the second example or the third example of the operation flow, the optimal solution calculation device 81 for an optimization problem in Embodiment 1 can prevent the calculation from not being completed in a preset cycle due to an increase in the iteration count of the optimization calculation step of step ST2 and an increase in the calculation time.

The second example of the operation flow in the update unit 300 shown in FIG. 9 is different from the first example of the operation flow shown in FIG. 8 in that the update count determination step of step ST33 is changed to an update count determination step of step ST38. Differences from the first example of the operation flow sown in FIG. 8 will be mainly described. The update unit 300 executes the data update step of step ST31 and the calculation determination step of step ST37. The calculation determination in step ST37 includes the set update determination step of step ST32, the update count determination step of step ST38, the intermediate determination flag determination step of step ST35, and the result output step of step ST36. The update count determination step of step ST38 is executed by the update count determination unit 33. In the set update determination step of step ST32, when the equality constraint set S2ₖ and the equality constraint set S2ₖ+₁ are different, the process proceeds to step ST38.

In the update count determination step of step ST38, the update count determination unit 33 determines whether or not the calculation total count kt, which is the sum of the calculation iteration count k and the iterative solution calculation count j, has reached the upper limit value ktm of the total calculation count that is preset. If the calculation total count kt has reached the upper limit value ktm of the calculation total count, the process proceeds to step ST35. If the calculation total count kt has not reached the upper limit value ktm of the calculation total count, the update unit 300 outputs the equality constraint set S2ₖ+₁ and the solution wₖ₊₁ generated by the data update unit 31 to the optimization calculation unit 200 and ends the update step of step ST3. The end in this case is the update end. If the calculation total count kt has reached the upper limit value ktm of the calculation total count, the optimal solution calculation device 81 determines that the iteration upper limit has been reached and ends the calculation. If the calculation total count kt has reached the upper limit value ktm of the calculation total count, it can be said that the update count of the equality constraint set S2ₖ has reached an upper limit value. In this case, it is the complete end.

The third example of the operation flow in the update unit 300 shown in FIG. 10 is different from the first example of the operation flow shown in FIG. 8 in that the update count determination step of step ST33 is changed to an update count determination step of step ST39. Differences from the first example of the operation flow shown in FIG. 8 will be mainly described. The update unit 300 executes the data update step of step ST31 and the calculation determination step of step ST37. The calculation determination in step ST37 includes the set update determination step of step ST32, the update count determination step of step ST39, the intermediate determination flag determination step of step ST35, and the result output step of step ST36. The update count determination step of step ST39 is executed by the update count determination unit 33. In the set update determination step of step ST32, if the equality constraint set S2ₖ and the equality constraint set S2ₖ+₁ are different, the process proceeds to step ST39.

In the update count determination step of step ST39, the update count determination unit 33 determines whether the calculation iteration count k has reached the upper limit value km of the calculation iteration count that is preset or the iterative solution calculation count j has reached an upper limit value jma of the iterative solution calculation count that is preset. If the calculation iteration count k has reached the upper limit value km of the calculation iteration count or the iterative solution calculation count j has reached the upper limit value jma of the iterative solution calculation count, the process proceeds to step ST35, and if the calculation iteration count k has not reached the upper limit value km of the calculation iteration count or the iterative solution calculation count j has not reached the upper limit value jma of the iterative solution calculation count, the update unit 300 outputs the equality constraint set S2ₖ+₁ and the solution wₖ₊₁ generated by the data update unit 31 to the optimization calculation unit 200, and ends the update step of step ST3. The end in this case is the update end. If the calculation iteration count k has reached the upper limit value km of the calculation iteration count or the iterative solution calculation count j has reached the upper limit value jma of the iterative solution calculation count, the optimal solution calculation device 81 determines that the iteration upper limit has been reached and ends the calculation. If the calculation iteration count k has reached the upper limit value km of the calculation iteration count or the calculation total count kt has reached the upper limit value ktm of the calculation total count, it can be said that the update count of the equality constraint set S2ₖ has reached an upper limit value. In this case, it is the complete end.

As described above, the optimal solution calculation device 81 for an optimization problem in Embodiment 1 is an optimal solution calculation device for an optimization problem in which a solution to an input optimization problem is calculated via the processing by the update unit 300. The optimal solution calculation device 81 for an optimization problem includes: the initial condition generation unit 100 that acquires, as the inputs, the inequality constraint set S1 that is the set of inequality constraints with respect to an optimization problem, the evaluation function J, and the initial solution w₀ᵢₙ, generates the executable initial solution w₀ that satisfies all the inequality constraints in the inequality constraint set S1 on the basis of the initial solution w₀ᵢₙ, and generates the equality constraint set S2 from the inequality constraint set S1 with respect to the executable initial solution w₀, the equality constraint set S2 being the set of equality constraints where the equality sign holds; the optimization calculation unit 200 that calculates a solution of the simultaneous linear equation SLE generated from the equality constraint set S2ₖ (equality constraint set S2 or equality constraint set S2ₖ₊₁) and the evaluation function J with respect to the input solution (solution wₖ) that is the executable initial solution w₀ for the first time or the solution wₖ₊₁ updated by the update unit 300 for the next time or later, and calculates the evaluated solution y that minimizes or maximizes the evaluation function J; and the update unit 300 that determines the evaluated solution y output by the optimization calculation unit 200, generates the equality constraint set S2ₖ+₁ updated by updating the constraints to be satisfied by the evaluated solution y from the equality constraint set S2ₖ, and generates the input solution (solution wₖ₊₁) updated on the basis of the input solution (solution wₖ) and the evaluated solution y that are the previous solutions. The optimization calculation unit 200 includes: the initial norm calculation unit 22 that calculates the initial residual norm NR₀ from the initial residual vector rᵢₙ, which is the difference between the vector of the left side of the simultaneous linear equation SLE and the vector of the right side of the simultaneous linear equation SLE with respect to the input solution (solution wₖ); the iterative solution calculation unit 25 that performs the iterative method and calculates the iterative solution yⱼ, which is the solution for each iteration count (iterative solution calculation count j) of the simultaneous linear equation SLE; the norm calculation unit 26 that calculates the residual norm NRⱼ from the residual vector rⱼ, which is the difference between the vector of the left side of the simultaneous linear equation SLE and the vector of the right side of the simultaneous linear equation with respect to the iterative solution yⱼ calculated by the iterative solution calculation unit 25; and the convergence determination unit 27 that determines that the iterative solution yⱼ has converged when the residual norm NRⱼ is equal to or less than the convergence determination threshold value Nth, which is the larger one of the preset first threshold value Nt1 and the second threshold value Nt2 set on the basis of the relaxation parameter m and the initial residual norm NR₀, and outputs the iterative solution yⱼ that has been determined to have converged as the evaluated solution y. The update unit 300 determines that the evaluated solution y is the optimal solution wg1 when an update of the equality constraint set S2ₖ is determined to be unnecessary and the convergence determination threshold value Nth is the first threshold value Nt1 and outputs the optimal solution wg1 as the output solution wa that is the solution to an optimization problem. In the optimal solution calculation device 81 for an optimization problem in Embodiment 1 with the above configuration, the convergence determination unit 27 determines that the iterative solution yⱼ has converged when the residual norm NRj is equal to or less than the convergence determination threshold value Nth, which is the larger one of the preset first threshold value Nt1 and the second threshold value Nt2 set on the basis of the relaxation parameter m and the initial residual norm NR₀, and outputs the iterative solution yⱼ determined to have converged as the evaluated solution y, and the update unit 300 determines the evaluated solution as the optimal solution when an update of the equality constraint set S2ₖ is determined to be unnecessary and the convergence determination threshold value Nth is the first threshold value Nt1, so that a converged solution can be obtained in a situation where an calculation error contained in the residual vector rⱼ affects the calculation of the solution.

The optimal solution calculation method for an optimization problem in Embodiment 1 is an optimal solution calculation method for an optimization problem in which a solution to an input optimization problem is calculated via the processing by the update step. The optimal solution calculation method for an optimization problem includes: the initial condition generation step of acquiring, as the inputs, the inequality constraint set S1 that is the set of inequality constraints with respect to an optimization problem, the evaluation function J, and the initial solution w₀ᵢₙ, generating the executable initial solution wₒ that satisfies all the inequality constraints in the inequality constraint set S1 on the basis of the initial solution w₀ᵢₙ, and generating the equality constraint set S2 from the inequality constraint set S1 with respect to the executable initial solution wₒ, the equality constraint set S2 being the set of equality constraints where the equality sign holds; the optimization calculation step of calculating a solution of the simultaneous linear equation SLE generated from the equality constraint set S2ₖ (equality constraint set S2 or equality constraint set S2ₖ₊₁) and the evaluation function J with respect to the input solution (solution wₖ) that is the executable initial solution w₀ for the first time and the solution wₖ₊₁ updated by the update unit 300 for the next time or later, and calculating the evaluated solution y that minimizes or maximizes the evaluation function J; and the update step of determining the evaluated solution y output in the optimization calculation step, generating the equality constraint set S2ₖ+₁ updated by updating the constraints to be satisfied by the evaluated solution y from the equality constraint set S2ₖ, and generating the input solution (solution wₖ₊₁) updated on the basis of the input solution (solution wₖ) and the evaluated solution y that are the previous solutions. The optimization calculation step includes: the initial norm calculation step of calculating the initial residual norm NR₀ from the initial residual vector rᵢₙ, which is the difference between the vector of the left side of the simultaneous linear equation SLE and the vector of the right side of the simultaneous linear equation SLE with respect to the input solution (solution wₖ); the iterative solution calculation step of performing the iterative method and calculating the iterative solution yⱼ, which is the solution for each iteration count (iterative solution calculation count j) of the simultaneous linear equation SLE; the norm calculation step of calculating the residual norm NRⱼ from the residual vector rⱼ, which is the difference between the vector of the left side of the simultaneous linear equation SLE and the vector of the right side of the simultaneous linear equation with respect to the iterative solution yⱼ calculated by the iterative solution calculation step; and the convergence determination step of determining that the iterative solution yⱼ has converged when the residual norm NRⱼ is equal to or less than the convergence determination threshold value Nth, which is the larger one of the preset first threshold value Nt1 and the second threshold value Nt2 set on the basis of the relaxation parameter m and the initial residual norm NR₀, and outputting the iterative solution yⱼ that has been determined to have converged as the evaluated solution y. In the update step, it is determined that the evaluated solution y is the optimal solution wg1 when an update of the equality constraint set S2ₖ is determined to be unnecessary and the convergence determination threshold value Nth is the first threshold value Nt1, and the optimal solution wg1 is output as the output solution wa that is the solution to an optimization problem. In the optimal solution calculation method for an optimization problem in Embodiment 1 with the above configuration, in the convergence determination step, it is determined that an iterative solution yⱼ has converged when the residual norm NRⱼ is equal to or less than the convergence determination threshold value Nth, which is the larger one of the preset first threshold value Nt1 and the second threshold value Nt2 set on the basis of the relaxation parameter m and the initial residual norm NR₀, the iterative solution yⱼ determined to have converged is output as the evaluated solution y, and in the update step, the evaluated solution is determined as the optimal solution when an update of the equality constraint set S2ₖ is determined to be unnecessary and the convergence determination threshold value Nth is the first threshold value Nt1, so that a converged solution can be obtained in a situation where an calculation error contained in the residual vector rⱼ affects the calculation of the solution.

### Embodiment 2

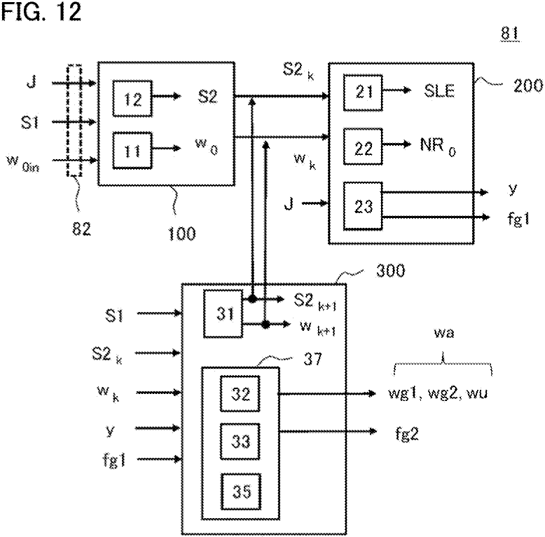

FIG. 11 is a diagram showing a first example of a functional block in an optimal solution calculation device for an optimization problem according to Embodiment 2, and FIG. 12 is a diagram showing a second example of a functional block in the optimal solution calculation device for an optimization problem according to Embodiment 2. In the optimal solution calculation device 81 of Embodiment 1, an example has been described in which the result output unit 35 does not determine the information of the intermediate determination flag fg1 in the intermediate determination flag determining step of step ST35 when the process proceeded from the update count determination step of step ST33. The optimal solution calculation device 81 according to Embodiment 2 is an example in which the result output unit 35 determines the information of the intermediate determination flag fg1 and outputs the output solution wa indicating the solution that has reached the iteration upper limit even when the process proceeded from the update count determination step of step ST33. In the first example of the optimal solution calculation device 81 for an optimization problem according to Embodiment 2 shown in FIG. 11, a first iterative upper limit solution wu1 and a second iterative upper limit solution wu2 are output as the output solution wa in addition to an optimal solution wg1 and a quasi-optimal solution wg2. In the second example of the optimal solution calculation device 81 for an optimization problem according to Embodiment 2 shown in FIG. 12, an iterative upper limit solution wu is outputted as the output solution wa in addition to the optimal solution wg1 and the quasi-optimal solution wg2. The optimal solution calculation device 81 of Embodiment 2 is different from the optimal solution calculation device 81 of Embodiment 1 in the operation of the result output unit 35 of the update unit 300. Differences from the optimal solution calculation device 81 of Embodiment 1 will be mainly described.

In the first example of the operation flow in the update unit 300 shown in FIG. 8, in the case where the process proceeds from the set update determination step of step ST32 to the intermediate determination flag determination step of step ST35, since the input data is not updated even if the calculation is performed by the optimization calculation unit 200, a solution improved from the current solution cannot be obtained. In this case, it can be said that the solution is a completely converged solution. In the case where the process proceeds to the intermediate determination flag determination step of step ST35 after the update count determination step of step ST33, although it is the case where the current solution can be improved because the data update is performed in the set update determination step of step ST32, in some cases, the intermediate determination flag fg1 may include the first convergent solution or the second convergent solution in the convergence determination step of step ST44. Since the first convergent solution satisfies the first threshold value Nt1, it is a solution that satisfies the preset first tolerance of the solution and is a sufficiently optimized solution. The second converged solution is a solution satisfying the preset second tolerance of the solution that is less strict than the first tolerance and is a quasi-optimized solution.

In the intermediate determination flag determination step of step ST35, the result output unit 35 determines information of the intermediate determination flag fg1. The result output unit 35 generates the determination flag fg2 indicating the optimal solution when the process has proceeded from the set update determination step of step ST32 and the intermediate determination flag fg1 indicates the first convergent solution. The result output unit 35 generates the determination flag fg2 indicating the quasi-optimal solution when the process has proceeded from the set update determination step of step ST32 and the intermediate determination flag fg1 indicates the second convergent solution. In the case where the process has proceeded from the update count determination step of step ST33, the result output unit 35 makes the determination as follows and generates the determination flag fg2.

The result output unit 35 generates the determination flag fg2 indicating the first iterative upper limit solution when the process has proceeded from the update count determination step of step ST33 and the intermediate determination flag fg1 indicates the first convergent solution. The result output unit 35 generates the determination flag fg2 indicating the second iterative upper limit solution when the process has proceeded from the update count determination step of step ST33 and the intermediate determination flag fg1 indicates the second convergent solution. For example, in the case where the determination flag fg2 is a 3-bit signal, if the determination flag fg2 is 7, it can indicate an optimal solution, and if the determination flag fg2 is 6, it can indicate a quasi-optimal solution. Further, if the determination flag fg2 is 3, it can indicate the first iterative upper limit solution, and if the determination flag fg2 is 2, it can indicate the second iterative upper limit solution.

In a result output step of step ST36, the result output unit 35 outputs the output solution wa and the determination flag fg2. The result output unit 35 outputs the evaluated solution y as the output solution wa of the optimal solution, namely, the optimal solution wg1, and outputs the determination flag fg2 indicating the optimal solution when the process has proceeded from the set update determination step of step ST32 and the intermediate determination flag fg1 indicates the first convergent solution. The result output unit 35 outputs the evaluated solution y as the output solution wa of the quasi-optimal solution, namely, the quasi-optimal solution wg2, and outputs the determination flag fg2 indicating the quasi-optimal solution when the process has proceeded from the set update determination step of step ST32 and the intermediate determination flag fg1 indicates the second convergent solution. The result output unit 35 outputs the output solution wa and the determination flag fg2 as follows when the process has proceeded from the update count determination step of step ST33.

The result output unit 35 outputs the evaluated solution y as the output solution wa of the first iterative upper limit solution, namely, the first iterative upper limit solution wu1, and outputs the determination flag fg2 indicating the first iterative upper limit solution when the process has proceeded from the update count determining step of step ST33 and the intermediate determination flag fg1 indicates the first convergent solution. The result output unit 35 outputs the evaluated solution y as the output solution wa of the second iterative upper limit solution, namely, the second iterative upper limit solution wu2, and outputs the determination flag fg2 indicating the second iterative upper limit solution when the process has proceeded from the update count determining step of step ST33 and the intermediate determination flag fg1 indicates the second convergent solution. The optimal solution wg1, the quasi-optimal solution wg2, the first iterative upper limit solution wu1, and the second iterative upper limit solution wu2, which are output as the output solution wa, are all converged solutions. The first iterative upper limit solution wu1 can also be said to be a solution output as the output solution wa for the solution to an optimization problem when the evaluated solution y is determined as the first iterative upper limit solution and the evaluated solution y is not determined as the optimal solution wg1 or the quasi-optimal solution wg2 in the case where the convergence determination threshold value Nth is the first threshold value Nt1 and in the case where the process proceeded via the update count determination step of step ST33 and the update count for the equality constraint set S2ₖ has reached the upper limit value. The second iterative upper limit solution wu2 can also be said to be a solution output as the output solution wa for the solution to an optimization problem when the evaluated solution y is determined as the second iterative upper limit solution and the evaluated solution y is not determined as the optimal solution wg1 or the quasi-optimal solution wg2 in the case where the convergence determination threshold value Nth is the second threshold value Nt2 and in the case where the process has proceeded via the update count determination step of step ST33 and the update count for the equality constraint set S2ₖ has reached the upper limit value.

In the intermediate determination flag determination step of step ST35, if the intermediate determination flag fg1 does not indicate the first convergent solution or the second convergent solution, the result output unit 35 determines that the first convergent solution or the second convergent solution is not obtained, and outputs the determination flag fg2 indicating no solution in the result output step of step ST36. In this case, the output solution wa is not output. For example, the determination flag fg2 indicating no solution is 1.

Since the first example of the optimal solution calculation device 81 of Embodiment 2 outputs one of the optimal solution wg1, the quasi-optimal solution wg2, the first iterative upper limit solution wu1, and the second iterative upper limit solution wu2 as the output solution wa, in a device that acquires the output solution wa from the first example of the optimal solution calculation device 81 of Embodiment 2 or in a process of the subsequent stage, it is possible to grasp the output solution wa as the optimal solution wg1, the quasi-optimal solution wg2, the first iterative upper limit solution wu1, and the second iterative upper limit solution wu2. Therefore, in the device that acquires the output solution wa from the first example of the optimal solution calculation device 81 of Embodiment 2 or in the process of the subsequent stage, it can be confirmed whether or not to adopt the output solution wa, and it is possible to change the process depending on the output solution wa to be adopted.

Although, as the first example of the optimal solution calculation device 81 of Embodiment 2, one of the optimal solution wg1, the quasi-optimal solution wg2, the first iterative upper limit solution wu1, and the second iterative upper limit solution wu2 is output as the output solution wa, the iterative upper limit solution wu may be output instead of the first iterative upper limit solution wu1 and the second iterative upper limit solution wu2 as in the second example of the optimal solution calculation device 81 of Embodiment 2 shown in FIG. 12. Differences from the first example of the optimal solution calculation device 81 of Embodiment 2 will be mainly described.

In the intermediate determination flag determination step of step ST35, when the process has proceeded from the update count determination step of step ST33, the result output unit 35 makes the determination as follows and generates the determination flag fg2. The result output unit 35 generates the determination flag fg2 indicating the iterative upper limit solution when the process has proceeded from the update count determination step of step ST33 and the intermediate determination flag fg1 indicates the first convergent solution or the second convergent solution. For example, in the case where the determination flag fg2 is a 3-bit signal, if the determination flag fg2 of 7, it can indicate an optimal solution, if the determination flag fg2 of 6, it can indicate a quasi-optimal solution, and if the determination flag fg2 of 4, it can indicate an iterative upper limit solution.

In the result output step of step ST36, when the process has proceeded from the update count determination step of step ST33, the output solution wa and the determination flag fg2 are outputted as follows. The result output unit 35 outputs the evaluated solution y as the output solution wa of the iterative upper limit solution, namely, the iterative upper limit solution wu, and outputs the determination flag fg2 indicating the iterative upper limit solution when the process has proceeded from the update count determination step of step ST33 and the intermediate determination flag fg1 indicates the first convergent solution or the second convergent solution. All of the optimal solution wg1, the quasi-optimal solution wg2, and the iterative upper limit solution wu output as the output solution wa are converged solutions. The iterative upper limit solution wu can also be said to be a solution output as the output solution wa for the solution to an optimization problem when the evaluated solution y is determined as the iterative upper limit solution and the evaluated solution y is not determined as the optimal solution wg1 or the quasi-optimal solution wg2 in the case where the convergence determination threshold value Nth is the first threshold value Nt1 or the second threshold value Nt2 and in the case where the process has proceeded via the update count determination step of step ST33 and the update count for the equality constraint set S2ₖ has reached the upper limit value.

Since the second example of the optimal solution calculation device 81 of Embodiment 2 outputs one of the optimal solution wg1, the quasi-optimal solution wg2, and the iterative upper limit solution wu as the output solution wa, in a device that acquires the output solution wa from the second example of the optimal solution calculation device 81 of Embodiment 2 or in a process of the subsequent stage, it is possible to grasp the output solution wa as the optimal solution wg1, the quasi-optimal solution wg2, and the iterative upper limit solution wu. Therefore, in the device that acquires the output solution wa from the second example of the optimal solution calculation device 81 of Embodiment 2 or in the process of the subsequent stage, it can be confirmed whether or not to adopt the output solution wa, and it is possible to change the process depending on the output solution wa to be adopted.

The optimal solution calculation device 81 of Embodiment 2 has been described using the first example of the operation flow in the update unit 300 in FIG. 8. However, in the optimal solution calculation device 81 of Embodiment 2, the update unit 300 may operate according to the operation flow shown in FIGS. 9 or 10. When the update unit 300 operates according to the operation flow of FIG. 9, the update count determination step of step ST33 is replaced with the update count determination step of step ST38. When the update unit 300 operates according to the operation flow of FIG. 10, the update count determination step of step ST33 is replaced with the update count determination step of step ST39. Even in this case, since the first example of the optimal solution calculation device 81 of Embodiment 2 outputs one of the optimal solution wg1, the quasi-optimal solution wg2, the first iterative upper limit solution wu1, and the second iterative upper limit solution wu2 as the output solution wa, in the device that acquires the output solution wa from the first example of the optimal solution calculation device 81 of Embodiment 2 or in the process of the subsequent stage, it is possible to grasp the output solution wa as the optimal solution wg1, the quasi-optimal solution wg2, the first iterative upper limit solution wu1, and the second iterative upper limit solution wu2. In addition, since the second example of the optimal solution calculation device 81 of Embodiment 2 outputs one of the optimal solution wg1, the quasi-optimal solution wg2, and the iterative upper limit solution wu as the output solution wa, in the device that acquires the output solution wa from the second example of the optimal solution calculation device 81 of Embodiment 2 or in the process of the subsequent stage, it is possible to grasp the output solution wa as the optimal solution wg1, the quasi-optimal solution wg2, and the iterative upper limit solution wu.

Note that, although various exemplary embodiments and examples are described in the present application, various features, aspects, and functions described in one or more embodiments are not inherent in a particular embodiment and can be applicable alone or in their various combinations to each embodiment. Accordingly, countless variations that are not illustrated are envisaged within the scope of the art disclosed herein. For example, the case where at least one component is modified, added or omitted, and the case where at least one component is extracted and combined with a component in another embodiment are included.

### DESCRIPTION OF REFERENCE NUMERALS AND SIGNS

25: iterative solution calculation unit, 26: norm calculation unit, 27: convergence determination unit, 35: result output unit, 81: optimal solution calculation device for optimization problem, 100: initial condition generation unit, 200: optimization calculation unit, 300: update unit, fg2: determination flag, J: evaluation function, j: iterative solution calculation count, jma: upper limit value of iterative solution calculation count, k: calculation iteration count, km: upper limit value of calculation iteration count, kt: calculation total count, ktm: upper limit value of calculation total count, m: relaxation parameter, NR₀: initial residual norm, NRⱼ: residual norm, Nt1: first threshold value, Nt2: second threshold value, Nth: convergence determination threshold value, rᵢₙ: initial residual vector, rⱼ: residual vector, S1: inequality constraint set, S2: equality constraint set, S2ₖ: equality constraint set, S2ₖ₊₁: equality constraint set, SLE: simultaneous linear equation, w₀: executable initial solution, w₀ᵢₙ: initial solution, wa: output solution, wg1: optimal solution, wg2: quasi-optimal solution, wₖ: solution, wₖ₊₁: solution, wu: iterative upper limit solution, wu1: first iterative upper limit solution, wu2: second iterative upper limit solution, y: evaluated solution, yⱼ: iterative solution

1. An optimal solution calculation device for an optimization problem calculates a solution to an input optimization problem via processing by an update circuit, the device comprising:
an initial condition generation circuitry to acquire, as inputs, an inequality constraint set that is a set of inequality constraints with respect to the optimization problem, an evaluation function, and an initial solution, generate an executable initial solution that satisfies all inequality constraints in the inequality constraint set based on the initial solution, and generate an equality constraint set from the inequality constraint set with respect to the executable initial solution, the equality constraint set being a set of equality constraints where an equality sign holds;
an optimization calculation circuitry to calculate a solution of a simultaneous linear equation generated from the equality constraint set and the evaluation function with respect to an input solution that is the executable initial solution for a first time or a solution updated by the update circuitry for a next time or later, and calculate an evaluated solution that minimizes or maximizes the evaluation function; and
the update circuitry to determine the evaluated solution output by the optimization calculation circuitry, generate the equality constraint set updated by updating constraints to be satisfied by the evaluated solution from the equality constraint set, and generate the input solution updated based on the input solution and the evaluated solution that are previous solutions, wherein
the optimization calculation circuitry includes:
an initial norm calculation circuitry to calculate an initial residual norm from an initial residual vector that is a difference between a vector of a left side of the simultaneous linear equation and a vector of a right side of the simultaneous linear equation with respect to the input solution;
an iterative solution calculation circuitry to perform an iterative method and calculate an iterative solution, the iterative solution being a solution for each iteration count of the simultaneous linear equation;
a norm calculation circuitry to calculate a residual norm from a residual vector, the residual vector being a difference between the vector of the left side of the simultaneous linear equation and the vector of the right side of the simultaneous linear equation with respect to the iterative solution calculated by the iterative solution calculation circuitry; and
a convergence determination circuitry to determine that the iterative solution has converged when the residual norm is equal to or less than a convergence determination threshold value, the convergence determination threshold value being a larger one of a preset first threshold value and a second threshold value set based on a relaxation parameter and the initial residual norm, and output the iterative solution that has been determined to have converged as the evaluated solution, wherein
the update circuitry determines the evaluated solution as an optimal solution when an update of the equality constraint set is determined to be unnecessary, and the convergence determination threshold value is the first threshold value and outputs the optimal solution as an output solution that is a solution to the optimization problem.

2. The optimal solution calculation device for an optimization problem according to claim 1, wherein a value of the relaxation parameter is a preset value from 10² to 10⁴ when a solution to the optimization problem is calculated using a single-precision type variable, and a value of the relaxation parameter is a preset value from 10⁸ to 10¹² when a solution to the optimization problem is calculated using a double-precision type variable.

3. The optimal solution calculation device for an optimization problem according to claim 1, wherein the update circuitry determines the evaluated solution as a quasi-optimal solution when an update of the equality constraint set is determined to be unnecessary, and the convergence determination threshold value is the second threshold value and outputs the quasi-optimal solution as an output solution that is a solution to the optimization problem when the evaluated solution is not determined as the optimal solution.

4. The optimal solution calculation device for an optimization problem according to claim 3, wherein the update circuitry, when an update count of the equality constraint set reaches an upper limit value, determines the evaluated solution as a first iterative upper limit solution when the convergence determination threshold value is the first threshold value, determines the evaluated solution as a second iterative upper limit solution when the convergence determination threshold value is the second threshold value, and outputs, when the evaluated solution is not determined as the optimal solution or the quasi-optimal solution, one of the first iterative upper limit solution and the second iterative upper limit solution as an output solution that is a solution to the optimization problem.

5. The optimal solution calculation device for an optimization problem according to claim 3, wherein the update circuitry, when an update count of the equality constraint set reaches an upper limit value, determines the evaluated solution as an iterative upper limit solution when the convergence determination threshold value is the first threshold value or the second threshold value and outputs the iterative upper limit solution as an output solution that is a solution to the optimization problem when the evaluated solution is not determined as the optimal solution or the quasi-optimal solution.

6. The optimal solution calculation device for an optimization problem according to claim 3, wherein the update circuitry includes a result output circuitry to output a determination flag indicating whether the output solution is the optimal solution or the quasi-optimal solution.

7. The optimal solution calculation device for an optimization problem according to claim 4, wherein the update circuitry includes a result output circuitry to output a determination flag indicating that the output solution is one of the optimal solution, the quasi-optimal solution, the first iterative upper limit solution , and the second iterative upper limit solution.

8. The optimal solution calculation device for an optimization problem according to claim 5, wherein the update circuitry includes a result output circuitry to output a determination flag indicating that the output solution is one of the optimal solution, the quasi-optimal solution, and the iterative upper limit solution.

9. An optimal solution calculation method for an optimization problem calculates a solution to an input optimization problem via processing by an update step, the method comprising:
an initial condition generation step of acquiring, as inputs, an inequality constraint set that is a set of inequality constraints with respect to the optimization problem, an evaluation function, and an initial solution, generating an executable initial solution that satisfies all inequality constraints in the inequality constraint set based on the initial solution, and generating an equality constraint set from the inequality constraint set with respect to the executable initial solution, the equality constraint set being a set of equality constraints where an equality sign holds;
an optimization calculation step of calculating a solution of a simultaneous linear equation generated from the equality constraint set and the evaluation function with respect to an input solution that is the executable initial solution for a first time or a solution updated in the update step for a next time or later, and calculating an evaluated solution that minimizes or maximizes the evaluation function; and
the update step of determining the evaluated solution output in the optimization calculation step, generating the equality constraint set updated by updating constraints to be satisfied by the evaluated solution from the equality constraint set, and generating the input solution updated based on the input solution and the evaluated solution that are previous solutions, wherein
the optimization calculation step includes: an initial norm calculation step of calculating an initial residual norm from an initial residual vector, the initial residual vector being a difference between a vector of a left side of the simultaneous linear equation and a vector of a right side of the simultaneous linear equation with respect to the input solution;
an iterative solution calculation step of performing an iterative method and calculating an iterative solution, the iterative solution being a solution for each iteration count of the simultaneous linear equation;
a norm calculation step of calculating a residual norm from a residual vector, the residual vector being a difference between the vector of the left side of the simultaneous linear equation and the vector of the right side of the simultaneous linear equation with respect to the iterative solution calculated in the iterative solution calculation step; and
a convergence determination step of determining that the iterative solution has converged when the residual norm is equal to or less than a convergence determination threshold value, the convergence determination threshold value being a larger one of a preset first threshold value and a second threshold value set based on a relaxation parameter and the initial residual norm, and outputting the iterative solution that has been determined to have converged as the evaluated solution, wherein
the update step determines the evaluated solution as an optimal solution when an update of the equality constraint set is determined to be unnecessary, and the convergence determination threshold value is the first threshold value and outputs the optimal solution as an output solution that is a solution to the optimization problem.

10. The optimal solution calculation method for an optimization problem according to claim 9, wherein the update step determines the evaluated solution as a quasi-optimal solution when an update of the equality constraint set is determined to be unnecessary, and the convergence determination threshold value is the second threshold value and outputs the quasi-optimal solution as an output solution that is a solution to the optimization problem when the evaluated solution is not determined as the optimal solution.

11. The optimal solution calculation device for an optimization problem according to claim 2, wherein the update circuitry determines the evaluated solution as a quasi-optimal solution when an update of the equality constraint set is determined to be unnecessary, and the convergence determination threshold value is the second threshold value and outputs the quasi-optimal solution as an output solution that is a solution to the optimization problem when the evaluated solution is not determined as the optimal solution.
